(19) United States
(12) Patent Application Publication
(10) Pub. No.: US 2002/0157573 A1
(43) Pub. Date: Oct. 31, 2002

(54) Hydraulic cement coatings and method of forming and applying the coatings

(76) Inventor: Alwin W. Pellett, Appleton, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 09/776,300

(22) Filed: Feb. 2, 2001

(51) Int. Cl. C04B 14/38; C04B 24/00

(52) U.S. Cl. 106/400; 106/644; 106/692; 106/724

(57) ABSTRACT

Dry mixes for hydraulic cement coatings for masonry, plastic insulating and dry wall substrates includes selective mineral aggregates, water reducer, and fine ceramic fibers, in various proportions for the different substrates. The ceramic fibers expand in the water of the applied coating and are trapped within the small recesses in the substrates. The ceramic fibers include different micron sizes in the range of 20 to 40 for masonry about 120 microns for plastic insulating substrates particularly foam plastic substrates. The fibers expand in the wet coating applied to substrates and remain in that state to bond to the substrates.

### BACKGROUND OF THE INVENTION

This invention relates to the hydraulic cement based coatings including the method of forming coatings and applying to an appropriate masonry and plastic foam substrate.

Hydraulic cement based coatings are often applied as protective and decorative coatings on various plastic structures including various foam, masonry and other cement based construction materials as well as steel substrates. U.S. Pat. No. 4,088,804 which issued May 9, 1978 discloses a cementeous coating and method of forming the same in which hydraulic cement is mixed with various components of mineral aggregates, silicate sand and other components to form a cement component which is mixed with a liquid component of water and polymer emulsion to provide a mixture for application to a substrate. The above and other patents disclose various formulations as well methods of application to various substrates.

### SUMMARY OF THE INVENTION

The present invention is particularly directed to providing an integrated composite of particular inorganic components added to a hydraulic cement, particularly, Portland cements and calcium aluminate cement, with particular aggregates and an emulsion and water to form the coating. The coatings of the present invention include specific coating for application to masonry substances and other similar but different coatings for application to insulating substrates including plastic substrates and particularly foam plastic substrates such as Styrofoam and to plaster board and particularly gypson board.

The hydraulic cements and the emulsions are well known and disclosed in the prior art, including the referenced U.S. Pat. No. 4,088,804.

The coatings of this invention are therefore widely used as a protective surface to foam substrates used for insulation and other foam substrates and also to masonry and related concrete products and substrates. The coating creates a protective surface which prevents damage when the surface is subjected to weathering conditions, chemical condition, physical engagement and the like. The coating may function as a shield as well as provide additional structure integrity.

An effective inorganic coating must firmly bond to the substrate and preferably form a waterproof surface as well as a generally protective surface. The coating must in many instances prevent penetration of surface moisture while allowing water vapor pass through and from the coating.

Masonry coatings preferably permit application for restoration of severely deteriorated masonry of concrete products. If the surface defect exposes rebars, mesh or the like, a proper coating may restore the function as well as appearance to the original construction.

Coatings which are applied to an insulation substrate and particularly foam substrates are generally different than a coating applied to a masonry product, even though the coatings may include generally similar formulations: each formulation requires selected additions of specific inorganic components to the basic elements to function in each application.

The present invention combines hydraulic cement and generally either sand, to form a mix which is combined with a controlled quantity of a synthetic emulsion and water to form a coating specially formulated for application to the insulation substrates and the like or to a masonry surface or a substrate.

The coating may also be produced for application to gypsum board and the like.

The mix may be formed with essential modifying components; with the mix subsequently mixed on-site with hydraulic cement and the basic sand as well as the emulsion and water; as this creates a desirable cost effective system by avoiding assembly and shipment of the various heavy, large components which are conveniently provided and mixed with the basic modifying components at or close to the coating site.

The inorganic coatings of the present invention will provide weather protection in all climatic conditions. The coatings will protect the outdoor structures as well as indoor installations in extreme atmospheres such as encountered in processing plants. The coatings further function to prevent excessive abrasion of the covered substrate surface.

The inorganic coatings are formed of materials which further create a non-hazardous condition to the personnel preparing and applying the mixes and the final coating to the substrate. The coating also creates a non-contaminating atmosphere at the final product.

The coating is formed with special expandable fibers which provide a particularly unique reinforcement of the coating and thereby create a strong, long-life coating on the substrate. The dry components are mixed with a synthetic emulsion and water which function as a film former and water base binders. The emulsion and the water base hydraulic cement and sand with other active components form a stable coating which can be applied to a substrate by spraying, troweling and the like. Various emulsions of different combinations are well known and typical film forms emulsions are set forth in the description of the embodiments of the invention.

Each of the preferred mixes, as subsequently described, includes unique dispersed fine ceramic fibers. The fibers are expandable mineral fibers, which are processed to various degrees of fineness and added in different ratios to all coatings, including both plastic coatings and film coatings for application to either masonry or to insulation substrates, and plaster boards, as more fully set forth herein.

This invention utilizes numerous inorganic components that perform an integral function with the primary materials of hydraulic cement such as Portland cement and in most coatings silica sand. These inorganic components are proportioned with a related primary materials, as listed below, into a powder pre-mix. The pre-mix is then mixed with a selected synthetic emulsion and water to a predetermined ratio and mix rate to form a final mixture for coating an appropriate substrate.

The application of these coatings are commonly sprayed with mechanical sprayers or troweled onto the selected substrates. The substrates to which these protective coatings are to be applied determine the selection of the composite mix and its mixing ratio to powder, emulsion and water. The different and related coatings are applied to and function to protect insulation foamed board and other foam form, and to protect masonry and related concrete structural members and substrates from weathering conditions and harsh chemical conditions.

The dry mix of inorganic coatings within the scope of the present invention includes various combinations of the following elements or components. The following discloses specific components which are combined to produce the mixes for the various coatings. Each component is identified by the generic name of the product or by a well known trade name, with the basic chemical formula for each component set forth for fully disclosing the required and preferred components in each coating. The particular source for any component will be readily selected based on the chemical formula. The component name is used for ease and clarity of description herein.

The separate components and the functions thereof is as follows:

1. White Portland Cement Ca3 Al2O5 Ca2 SiO4 Classified as type I is a high alumina and usually processed with lime to maintain whiteness.

2. Gray Portland Cementer Ca3 Al2O6 Fe2O3 CaO Classified as type I or type I.

3. Calcium Aluminate CaO SiO2 Al2O3 Fe2 O3 may be a main component or a component addition. The component is mainly calcium aluminate and is used in Portland cement mixtures for producing early hardness of the coating and for use in severe exposure conditions such as high reducing gases and saturated chemical dispersions. It is also used as the base hydraulic cement in certain mixes.

4. Silica Sand SiO2 functions as a major structure embodiment of the matrix, after the mix is sprayed or otherwise applied on the substrate and is cured.

5. Amorphous Silica SiO2, a crystalline silica is a pulverized quartz that assists in the composite structure of the coating in the interbonding with the cements, and is supportive of the resistance to acids, water penetration and chemical watering.

6. Fly ash AiO2 AlO2 O3 Fe3O2 is a pazzalan, a silicate and a aluminous material the presence of moisture, will combine with the lime librated during the hydration of cement, and produces a resistance to sulfate, a common deteriorating chemical to most coatings. 7. Perlite SiO2 AlO2O3 K20 Na2O, a nonhygroscopic component of the powder mix assists in stabilizing the matrix as it cures and produces a resistance to surface crazing and assist in allowing expansion and contraction change of the composite after it is cuted.

8. Zeothis, a precipitated Amorpheus Silicon Dioxide (Si)2) contributes to the retention on a vertical and overhead spray on surface, and assists in keeping other component particles in suspension and more uniformly dispersed. Integrated with the amorphous silica SiO2 (S) is Zeothis (Z) form a thixotrope to control the viscosity of the slurry when the powder is mixed with water.

9. Ceramic Fiber a aluminosilicate Al2 O3 SiO2 Ca P2 O5. A predominant unique component for structural performance are ceramic fibers, which are used in all the mixes. These are dispersed by hydrolysis. Although a difficult component to properly disperse, extensive preparation of ceramic fibers creates small fibers which produce substantial improvement and provide reinforcement, reduce cracking, and allow more flexibility of the cured products. The fibers function well at elevated temperatures of 2300 F and are very resistant to chemical attack.

After being dispersed by mixing and hydrolytic expansion, their structural position as expanded is maintained when the matrix is cured.

10. Cab-O-Sil, SiO2. An additional thirotrope is hydrophobic fumed silica which assists in water resistance, reduces spray on sagging and good anti-settling.

11. Van-Sil Wollastonite CaSiO3. An industrial mineral, provides a prime function with the powder mix and enhances the compound by increasing flexural strength and modulus, increasing tensile strength, decreasing water absorption and improves dimensional stability and good thermal shock properties.

12. Borem is a sodium salt of condensed Sulfated Naphthalene and functions as a water reducer in the mix and is used for sprayable mixes. Reduced water allows the sprayed on mix to maintain adherence to the substrate especially when sprayed onto a vertical and overhead surface.

13. Gypsum CaSO4-0.55 H2O is mixed with the powder to aid in a slight stiffing of the water mix as it is applied. When mixed with water and allowed to re-hydrate. Then after the early set, the heat of hydration allows the gypsum a nominal expansion. This is to offset the amount of cure shrinkage that occurs when Portland cement matrixes.

14. Lithium Nitrate Li2NO3 (Linx), is used with Class “F” fly ash (6) as a pozzalith to reduce the gel formation, thus reducing water absorption and expansion. Sources of silica sand have alkalic reactivity, usually sodium and potassium, a dissolution of the amorphous silica forming an alkali-silica gel which absorbs moisture and causes expansion in thin film sections results internal stress and cracking can occur. Linx-Lithum Nitrate is an ASR (alkali-silica reactivity) inhibitor, silica sand as an aggregate that are of alkali base will react with hydraulic cement and form an alkali/silica gel. Under conditions of available moisture the gel will expand and reduce stress cracks, cracks can provide pathways for water, sulfates, chlorides and other deteriorating materials to deteriorate the hydraulic cement base mix. Linx-Lithium Nitrate is used as a precaution when it is not totally known the alkalinity of the silica sand being used.

15. Titanium dioxide TiO2 is one of numerous color pigments, predominantly used with white cement for white coatings. Other known natural inorganic earthen materials are processed and added to these formulations to produce a desired color.

16. Lime CaO in the powder mix reacts with the water to form a putty-like component to aid in surface bonding and total cohesiveness of the mix after it is sprayed.

17. Sil-co-sil SiO2. A finely ground microcrystalline sand, is the main structural member next to silica sand in these plastic and spray-on formulations. The interaction with the hydraulic cements and other silicas, which are inert, assist in sealing the substrate from water penetration after the coating has cured.

18. Melamine C3 H6 N6 functions as an amino cross linker, with adhesive junctions, with the hydrate silicates.

19. Volcanic Ash SiO2 Al2O3 Fe3O3 TiO2 CaO MgO is a natural component, ground and used to permit vitrification, or ceramic type, toughness and finishes in the coatings.

20 Melmont-F10 CaSO4 O5 H2O is a matrix water reducer and super plasticizer, and aids with flowability of the mix and sprayability.

21. Ceramic Micro spheres SiO2 Al2O3 Fe2O3 TiO2 are processed from fly ash to be high compressive strength. They replace silica sand in mixes requiring structural submix, where sand cannot be used because of potential silicosis restrictions and limitations.

22. Calcium Sterate CaCo3 is a modifier that reacts with fly ash to increase the water proofing of the cured plaster coatings.

23. Micro Silica assists the function of Portland Cement in its gel form to extend its cohesive film coating to achieve greater bond strength on the granular substructure of the cement.

24. Sodium Silica SiO2 N2O is an inorganic water soluble silicate which functions as a film binder for the powdered materials and a matrix binder to bond to substrates.

25. Polypropylene fibers are used with plastic mix coatings for reinforcement of thin film applications, where excessive use impact resistance is required. The fibrillated-net fibers (deformed) are mixed with the plastic matrix and sprayed or troweled onto the substrate.

26. Min-V-Sil is a high purity quality natural crystalline silica. The mineral is chemically inert and a high quality powder coating filler which also offers superior resistance to corrosion, acid and heat.

27. Eilkem is a water reducer.

As noted above and more fully developed hereinafter, the ceramic fibers as are an important and unique component in the coatings of the present invention. To promote the dispersal of the fibers within the final web mix, the fibers are reduced to micron sizes. The ceramic fibers are preferably processed by reducing the fibers in a hammer mill to a reduced fiber size. The fibers are then further reduced in a pulverizer unit to reduce the fibers to a range of about 20 to 40 microns for use in masonry and dry wall substrates and to a size of substantially 120 micron for use in foam plastic substrates. The above sizes are not limiting, but have been found to produce unused effective coatings.

All of the listed components perform as specified and function within the specified composite mix.

The hydraulic cements in a composite mix when mixed with water form a paste that covers the same grains. This paste also includes other hydrate reacting components of these mixes that adhere to the sand grains to form the composite structure of the coatings.

In addition to the structural bond of the hydraulic cement, film forming water base emulsion binders are employed. These emulsions are of numerous known combinations each having a gainful effect for the coatings bonding to form plastic substrates, such as Styrofoam and to the concrete substrates.

These film formers, water base binders are stable when mixed with hydraulic cement and other component materials of these mixes. Some of these film formers are: vinyl-chloride-vinylidene, chloride acrylic, styrene-butadiene copolymer, polyacrylic emulsion, melamine-formaldehyde and styrene acrylic copolymer. The ratio of application to the weight of cement component is 3 to 60 parts by weight.

The component materials, namely, hydraulic cement, graded silica sand and blended activating chemicals with binders and potable water, are used to formulate composites for protective coasting substrates for masonry, for expanded synthetic foam substrates, and wall board and particularly gypsum board.

The various mixes of the basic components is thus determined by both the substrate to be covered and the particular type of the coasting. Thus, the coating may be a relative thin film coating or a plastic coating and one which may or may not include a high density plastic for a masonry substrate. The coating produces a protective film.

### DETAILED DESCRIPTION OF THE INVENTION

The following embodiments describe separate preferred typical components for application to masonry substrates and for insulation and wall board substrates.

### Masonry Substrates

The performance of these coatings for masonry protection functions as an integral component with the in place concrete substrate. These formulated products form a waterproof layer by activation of the chemicals within the free lime and the capillary water in the concrete creating insoluble crystalline structures, which block the capillaries, and minor shrinkage cracks. This action will not allow permeation of water, but water vapor is allowed to pass. It is very critical that moisture vapor will migrate through the cured composite of the coatings, but not allow penetration of surface moisture.

The following fiber reinforced plaster sprayed onto masonry is very effective in restoration of severely deteriorated concrete. Areas that have spalled out to exposed rebar and mesh can readily be restored for function and appearance and most importantly to protection.

Composition mix for Masonry Plaster

| Component | Parts by weight |
|---|---|
| Gray Portland Cement | 100 |
| Silican Sand | 50-140 |
| Sil-Co-Sil | 20-80 |
| Fly Ash | 5-25 |
| Min U Sil | 5-15 |
| Ziothix | 0-20 |
| Perlite | 0-25 |
| Lime | 5-50 |
| Gypsum | 5-80 |
| Borem | 0-15 |
| Linx | 0-10 |
| Melamine | 0-30 |

Composition mix for thin film protective Masonry

| Component | Parts by weight |
|---|---|
| White Portland Cement | 100 |
| Calcium Aluminate | 50-140 |
| Zeothix | 0-20 |
| Cab-O-Sil | 5-40 |
| Sil Co Sil | 5-60 |
| Min-U-Sil | 10-60 |
| Melmont F-10 | 0-25 |
| Borem | 0-8 |
| Ceramic Fiber | 0-15 |

Composition mix for high density Masonry Plaster

| Component | Parts by weight |
|---|---|
| Calcium Aluminate | 100 |
| Fly Ash | 5-20 |
| Silica sand | 5-150 |
| Eilkern | 10-30 |
| Borem | 0-15 |
| Melmont F-10 | 0-15 |
| Linx | 0-10 |
| Sil-Co-Sil | 5-25 |
| Cab-O-Sil | 0-15 |
| Zeothix | 0-10 |
| Ceramic Fiber | 0-10 |

### Plastic and Foam Substrates

A homogeneous structure of the mix is predominantly developed in all substrates by the function of the hydraulic cement which has an outer layer of tricalcium silicate. The silicate layer products an integral bonding film about the granular of silica sand or other components as a bonding paste with other components such as an amorphus silica and super sil The hydraulic cement structure further includes dicalcium silicate which produces structural strength in the final cement composite and functions with the added water to relate to the binder of the mix, including the polymer emulsion in the web state, and finally maintains the bond after the coating is used.

In the present invention, the unique ceramic fibers, which are reduced to micron sizes, further contribute significantly to the bonding of the coating, and particularly to the bonding to a foam plastic and the like in which recesses are formed by the half cells exposed on the surface and as a result of the permanent expansion of the fibers within the recesses and openings, in the substrates, as set forth hereinafter.

The above formulations describe various typical compositions which can be modified in accordance with specific applications by those skilled in the art, recognizing that the preferred advantages of this system results with the use of the finely divided ceramic fibers.

Similar but different component mixes are prepared for application to insulation board or surfaces such as plastic board and particular expanded foam plastic boards, such as Styrofoam panels or boards and also for other types of substrates such as gypsum board.

The hydraulic cement is the primary structural binder of the composite powder mix when it is activated with water as in the masonry application. It is the prime purpose of foam system coatings designed to bond to the foam substrate, to produce some structural integrity, and hydrophobic (water repellent) properties.

The selection of a vinyl-acetate-acrylic polymer (of about 45-50% solids) is used as in the masonry application at a ratio of 6-25 parts to the 100 parts of cement. The polymer assists with the bond of the matrix to the foam board or foam form. As a support and bonding assistance, a pre-coat of a water reduced internally plasticized acrylic polymer is sprayed onto the foam prior to the spray of plaster mix.

The application of cementitious coatings onto expanded foam and other insulation type substrates has extreme limitations; primarily the structural make-up of the surface area and the composite of the foam may not be compatible with the prepared combination of the formulated coating. These inorganic foam coatings are functionable by the utilization of the binding characteristics of the synthetic emulsions and their reactiveness with elements in the mixed formulation. In addition to the adhesiveness of the gel formed with synthetic emulsions, there is a mechanical binding that is established when the fines of the formulated mix are penetrated into the porous surface of the foam substrate. These fines interact with the synthetic emulsion and water and expand during their hydration. This action is limited so as not to exceed the shear strength of the foam substrate.

The surface of foam plastic substrates have half cells and small recesses. The pulverized line ceramic fibers enter into the recesses or openings of the substrate. As a result of the water in the coating mix as applied to the substrates, the ceramic fibers expand within the cells and recesses and remain therein after the coating dries. Thus, the ceramic cells do not collapse with the drying of the substrate and the coatings and form a form bonding of the coating to the substrate.

The ceramic fibers applied to other surfaces enter many recesses or the like and also contribute to the bonding of the coating to the substrate.

The spray on surface coatings for expanded foam have a geotex performance, moisture will migrate out through the coatings. These spray on plaster coatings are formulated to allow thermo expansion and contraction of a semi rigid membrane that is compatible with a none equal expansion ratio substrate.

Examples of mixes used to coat expanded Styrofoam

| Component | Parts by weight |
|---|---|
| Gray Portland Cement | 100 |
| Silica Sand | 20-100 |
| Sil-Co-Sil | 0-25 |
| Zeothix | 0-8 |
| Fly Ash | 5-25 |
| Perlite | 0-10 |
| Ceramic Fiber | 0-12 |
| Borem 100 | 0-2 |
| Lime | 0-2 |
| Gypsum | 0-5 |

Composition mix for reinforced plaster for Styrofoam

| Component | Parts by weight |
|---|---|
| White Portland Sand | 100 |
| Silica Sand | 20-100 |
| Sil-Co-Sil | 0-25 |
| Zeothix | 0-8 |
| Fly Ash | 5-25 |
| Perlite | 0-10 |
| Ceramic Fiber | 0-18 |
| Borem-100 | 0-5 |
| Lime | 0-5 |
| Gypsum | 0-10 |
| Polypropylene Fibers | 0- |

A mix with fibrillated polypropylene fibers function to reinforce the coating applied to a foam structure or a masonry structure. For the expanded foam coating, the fibers are used where impact and utility service is a significant factor. The fibers are hydrophobic (non-absorptive) and improve the coating for masonry coating in contact to other fibrous reinforcement materials which are absorptive and may disintegrate the coating under a continued moisture exposure. In addition the impact resistance, the polypropylene fibers support the coating and resist major change in thermal variations.

The inventor has found the fiber base coating may also be advantageously applied to dry wall and particularly gypsum board.

Composition mix for Dry Wall

| Component | Parts by weight |
|---|---|
| White Portland Cement | 100 |
| Calcium Aluminate | 0-60 |
| Silica Sand | 5-140 |
| Titantium Dioxide | 0-20 |
| Perlite | 0-80 |
| Melmont F-10 | 0-15 |
| Ceramic Fiber | 0-20 |
| Zeothix | 0-15 |
| Cab-O-Sil | 0-15 |
| Van Sil | 0-60 |
| Melamine | 0-45 |
| Linx | 0-25 |

A composite designed to utilize near natural materials for application on to paper faced dry wall (gypsum board) and does not contain silica sand as the major structure base. there are application limits using silica sand, as a hazard for silicosis.

Composition mix

| Component | Parts by weight |
|---|---|
| Gray Portland Mix | 100 |
| Volcanic Ash | 0-40 |
| Wallastonite | 0-25 |
| Ceramic Fiber | 0-25 |

A composite for water proof mix for Dry Wall that does not include silica sand.

| Component | Parts by weight |
|---|---|
| White Portland Cement | 100 |
| Sil-Co-Sil | 0-20 |
| Van-Sil | 0-15 |
| Ziothix | 0-10 |
| Perlite | 0-10 |
| Ceramic Micro Spheres | 0-40 |
| Melamine | 0-10 |
| Ceramic Fiber | 0-20 |

A Dry Wall mix has also been formulated that does not use an acrylic binder.

| Component | Parts by weight |
|---|---|
| Calcium Aluminate | 100 |
| Sodium Silicate | 0-15 |
| Van Sil | 0-25 |
| Ceramic Fiber | 0-25 |

### Dry Wall Substrates

Paper faced dry wall, generally a typical gypsum board, may require a mix of components without a silica sand, where a hazard for silicasis may be present. Applicant has found a hydraulic cement may be formed using a mix of ceramic fiber and other forms of non-silica sand combined with an emulsion and water to cover dry wall products with a secure coating without silica sand.

All of the reviewed information on components mix combinations and their related functions are for coatings that are used for weather protection in all climatic conditions; for protection of structures; installations in extremes atmospheres in processing plants; and for protection to the substrate in excessive abrasion conditions.

All the inorganic components are mixed and function in their applications to establish a non-hazardous condition in preparation and are non-contaminating to the atmosphere and applicators.

These inorganic coatings, in addition to their bonding system and their weatherability, have a great advantage in that the composite mix includes expandable mineral fibers. These unique expandable fibers are processed in various degrees for fineness and used in differing ratios for all plaster and film coatings in the preferred embodiments. It is unique that these fibers, when reduced in particle size for a sprayable mix or thin film application, will expand and function as reinforcement. Other parts of the mix will reduce in section as it cures, by hydrolysis.

I claim:

1. A coating mix for combining with a base of hydraulic cement and a latex emulsion and water for applying a coating to a substrate; said coating mix comprising mineral aggregates, and non-metallic fibers, said fibers expanding upon wetting with water and maintaining said expanded state upon subsequent drying.

2. The coating of claim 1 wherein said fibers are ceramic fibers.

3. The coating of claim 2 wherein said coating is constructed and configured for application to a masonry substrate, and said fibers use no greater that about 40 microns.

4. The coating of claim 2 wherein said coating is constructed and configured for application to a plastic substrate, and said fibers are on the order of no greater than 20 to 40 microns.

5. The coating of claim 2 wherein said coating is constructed and configured for application to a form plastic substrate and said fibers are on the order of 120 microns.

6. The coating of claim 5 wherein the face of said plastic substrate has open cells.

7. The coating of claim 2 for applying the coating to a masonry substrate and to a foam insulating substrate with a latex emulsion and wherein said mineral aggregates and additional components include parts by weights; hydraulic cement 100; calcium aluminate 0 to 140; silic acid 0 to 140; sil-co-sil 5 to 80; flyash 0-25; min-u-sil 8-8; cuami ceramic fiber 5-25; Cab-o-Sil 0-40; Zeothix 0-20; Perlite 0-25; Lime 0-50; Gypsum 0-80; Borem 0-15; Linx 9-10; Melamine 0-30; Melmont F-10 0-25; Eilkem 0-30.

8. The coating of claim 1 for applying the coating as plastic to a masonry substrate comprising hydraulic cement 100, silica sand 50-140; Sil-Co-Sil 20-80; flyash 5-25; Min-U-Sil 20-80; ceramic fibers 5-25; Cab-O-Sil 5-15; Zeothix 0-20; Perlite 0-25; lime 5-50; gypsum 5-80; Borem 0-15; Linx 0-10; and Melamine 0-30.

9. The coating of claim 7 for applying the coating as a thin film to a masonry substrate, comprising hydraulic cement 100; calcium aluminate 50-140; Zeothix 0-20; Cab-O-Sil 5-40; Sil-Co-Sil 5-60; Min-U-Sil 10-60; Melmont F10 0-25; Borem 0-8; and ceramic fiber 0-15.

10. The coating of claim 7 for applying a high density masonry masonry plastic comprising calcium aluminate 100; flyash 5-20 Silica Sand 5-150; Eilkem 10-30; Borem 0-15; Melmont F-10 0-15; Linx 0-10; Sil-Co-Sil 5-25; Cab-O-Sil 0-15; Zeothix 0-10; and ceramic fibers 5-20.

11. The coating of claim 7 for applying a plaster coating to an expanded plastic substrate having open cells, comprising Portland Cement 100; Silica 20-100; Sil-Co-Sil 0-25; Zeothix 0-8; flyash 5-25; Perlite 0-10; ceramic fiber 0-12; Borem 100 0-20; lime 0-2; and gypsum 0-5.

12. The coating of claim 7 for applying a reinforced plaster for an expanded plastic substrate having open cells, comprising Portland cement 100; Silica sand 20-100; Sil-Co-Sil 0-25; Zeothix 0-10; flyash 5-25; Perlite 0-10; ceramic fiber 0-18; Borem 100 0-5; lime 0-5; gypsum 0-10; and polypropylene fibers 0-10.

13. The coating of claim 1 for applying a coating to a drywall substrate comprising Portland cement 100; gypsum; calcium aluminate 0-60; Silica sand 5-140; Perlite 0-80; Melmont F-10 0-15; ceramic fiber 0-20; Zeothix 0-15; Cal-O-Sil 0-15; Van Sil 0-60; Melamine 0-45; and Linx 0-25.

14. The coating of claim 2 for applying a coating to paper faced drywall comprising by parts Portland cement 100; ceramic fibers 0-25; volcanic ash 0-40; and Wallastronite 0-25.

15. The coating of claim 2 for applying a water proof coating to drywall comprising by parts Portland cement 100; Sil-Co-Sil 0-20; Zeothix 0-10; Perlite 0-10; Melamine 0-10; ceramic fibers 0-20; and additionally Van Sil 0-15 and ceramic microsphere 0-40.

16. The coating of claim 2 for applying a coating without a lot of binders, to a drywall substrate, comprising by parts calcium aluminate 100; ceramic fibers 0-25; Van Sil 0-25 and sodium silicate 0-15.

17. The coating of claim 2 wherein said ceramic fibers have a size substantially in the range of about 20 to 40 microns.

18. The coating of claim 2 wherein said ceramic fibers have a size no greater than about 120 microns.
